(19) United States
(12) Patent Application Publication
(10) Pub. No.: US 2009/0049644 A1
(43) Pub. Date: Feb. 26, 2009

(54) Multi-Stage Hinge Assembly

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/844,491

(22) Filed: Aug. 24, 2007

(51) Int. Cl. E05D 11/00; E05D 11/02; E05D 11/08

(52) U.S. Cl. 16/223

(57) ABSTRACT

A multi-stage hinge assembly includes a first coupling member adapted to fix with a portable computer and receivable with a second coupling member, a plurality of support members, a first positioning member, a plurality of resilient frictional devices, a second positioning member, a first position limiting member, a second position limiting member and a retainer. The first positioning member and the second positioning member are adapted to provide differential frictional forces. The first position limiting member and the second position limiting member include a plurality of the V-shaped lubricant holes adapted to maintain lubricant therebetween regardless whether the second coupling member is rotated clockwise/anticlockwise with the first coupling member.

### BACKGROUND OF THE INVENTION

1. Field of the Invention

The present invention relates to a hinge assembly, more particularly to a hinge assembly for a portable computer.

2. Description of the Related Art

Taiwan Pat. No. M305374 disclose a hinge assembly having the advantage of automatic locking, but it suffers several problems. One problem is that a computer or the like with this hinge assembly can not open/close with satisfactory steadiness and to be firmly remained in a static position. Another problem is that lubricant can not be transferred efficiently.

The present invention is, therefore, intended to obviate or at least alleviate the problems encountered in the prior art.

### SUMMARY OF THE INVENTION

A multi-stage hinge assembly includes a first coupling member adapted to fix with a portable computer and receive with a second coupling member, a plurality of support members, a first positioning member, a plurality of resilient frictional devices, a second positioning member, a first position limiting member, a second position limiting member and a retainer. The retainer is adapted to prevent the second coupling member, the plurality of support member, the first positioning member, the plurality of resilient frictional devices, and the second positioning member, the first position limiting member and the second position limiting member from disengaging with the first coupling member.

The second coupling member includes a first engagement portion pivotally mounted on the first coupling member and a second engagement portion adapted to fix with a portable computer.

The plurality of support members are pivotally mounted on the first coupling member and are engaged with the second coupling member.

The first positioning member defines a first contacting surface with a plurality of radially disposed gripping blocks formed thereon. Each gripping block is arcuate and has the same radius of curvature. Furthermore, each gripping block is disposed at different distances with respect to the first coupling member.

The resilient frictional devices are installed between the first positioning member and the retainer. Each resilient frictional device is separated by one support member.

The second positioning member defines a first contacting surface with a plurality of positioning slots corresponding with the plurality of gripping blocks. Each gripping block is adapted to complemently fit into the corresponding position slot and move in the positioning slot and on the first contacting surface of the second positioning member.

The first position limiting member is mounted on the first coupling member and includes a plurality of V-shaped lubricant holes for allowing lubricant to flow past the first position limiting member. The plurality of lubricant holes are grouped in pairs, with each pair including two lubricant holes having their open ends extending oppositely from each other and with each pair being disposed radially about the hole.

The second position limiting member is pivotally mounted on the first coupling member and includes a plurality of V-shaped lubricant holes. The lubricant holes are also grouped in pairs, with each pair including two lubricant holes having their open ends extending oppositely from each other. Furthermore, the second position limiting member includes a projection moveable within the position limiting area. The position limiting area is adapted to limit pivoting movement of the second position limiting member.

One objective of this invention is that the first positioning member and the second positioning member are adapted to provide differential frictional forces.

Another objective of this invention is that the plurality of the V-shaped lubricant holes are adapted to maintain lubricant between the first positioning limiting member and the second positioning limiting member regardless the second coupling member is rotated clockwise/anticlockwise with the first coupling member.

Yet another objective of this invention is to provide the plurality of resilient frictional devices and support members for allowing the portable computer or the like to open/close with greater steadiness and to be firmly remained in a static position.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a multi-stage hinge assembly of the present invention.

FIG. 2 is an exploded perspective view of FIG. 1.

FIG. 3 is an exploded perspective view taken from a different angle of view.

FIG. 4 is a cross-sectional view taken along line 4-4 of FIG. 1.

FIG. 5 is a cross-sectional view taken along line 5-5 of FIG. 1.

FIG. 6 is a cross-sectional view taken along line 6-6 of FIG. 1.

FIG. 7 is a side view illustrating the position of the first positioning member with respect to the second positioning member.

FIG. 8 is a view illustrating the position of the first positioning member with respect to the second positioning member, but from a different view to FIG. 7.

FIG. 9 is a cross-sectional view taken along line 9-9 of FIG. 7.

FIG. 10 is a side view illustrating a different position of the first positioning member with respect to the second positioning member.

FIG. 11 is a view illustrating the position of the first positioning member with respect to the second positioning member, but from a different view to FIG. 10.

FIG. 12 is a cross-sectional view taken along line 12-12 of FIG. 10.

FIG. 13 is a sectional view similar to FIG. 5, but with the multi-hinge assembly being rotated to a different position.

FIG. 14 is a cross-sectional view taken along line 14-14 of FIG. 13.

FIG. 15 is a side view illustrating a yet different position of the first positioning member with respect to the second positioning member.

FIG. 16 is a view illustrating the position of the first positioning member with respect to the second positioning member, but from a different view to FIG. 15.

FIG. 17 is a cross-sectional view taken along line 17-17 of FIG. 15.

### DETAILED DESCRIPTION OF THE PREFERRED EMBODIMENT

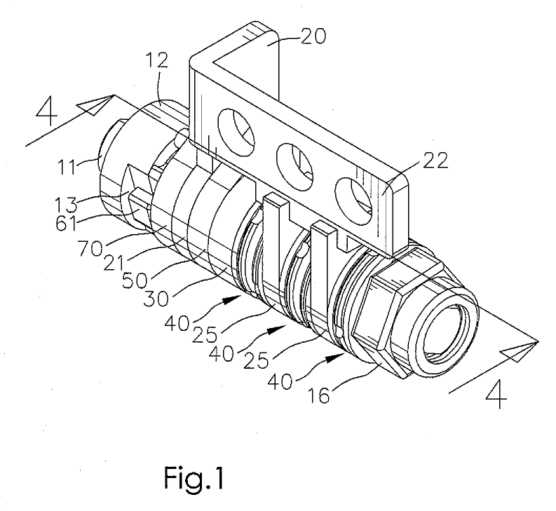

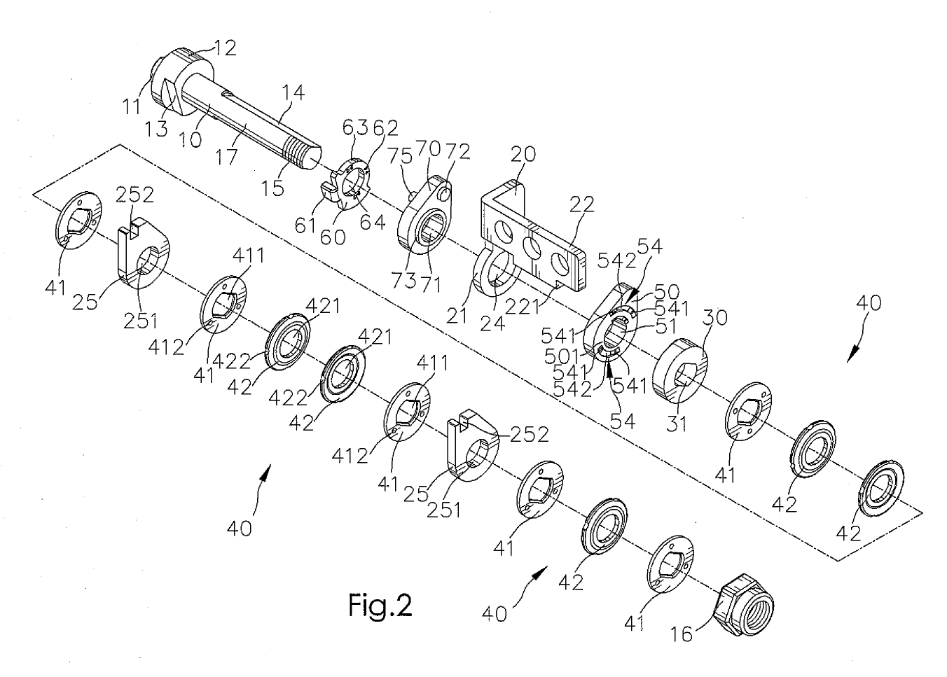

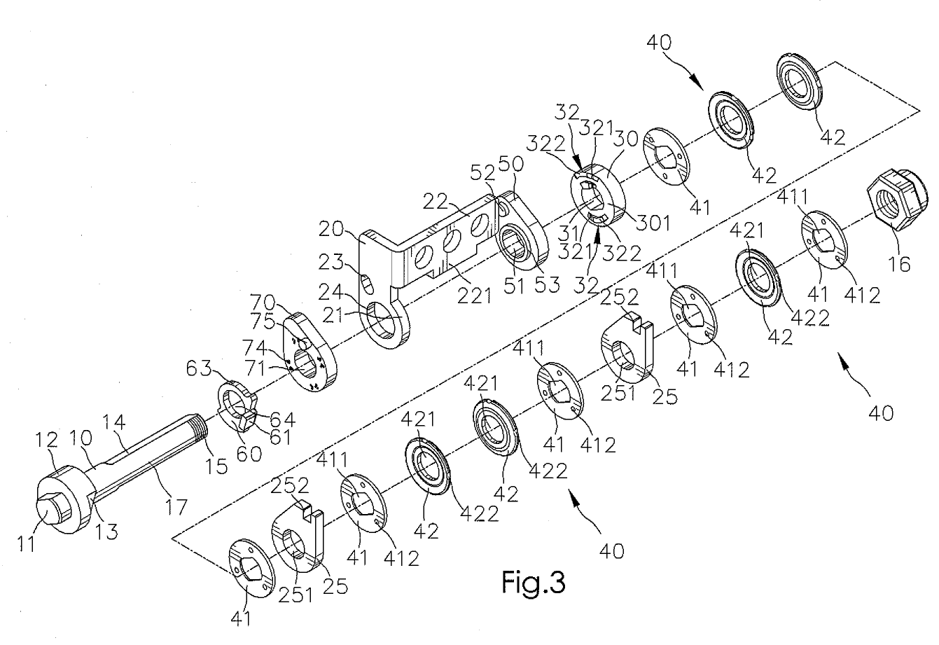

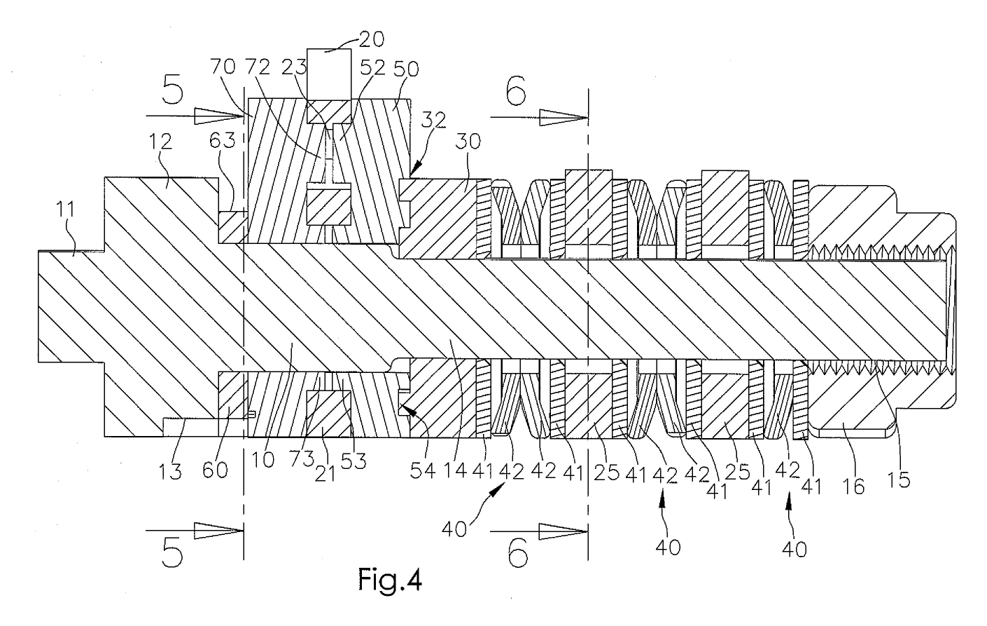

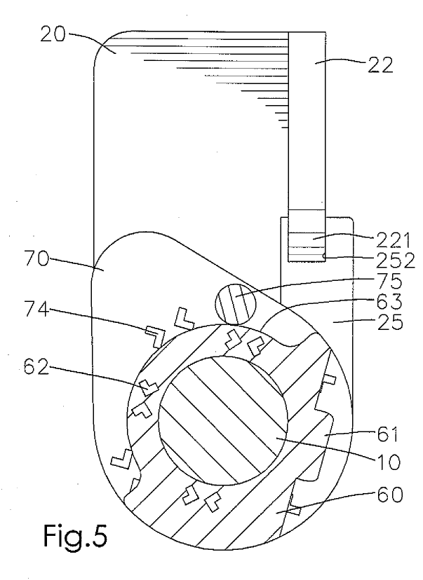

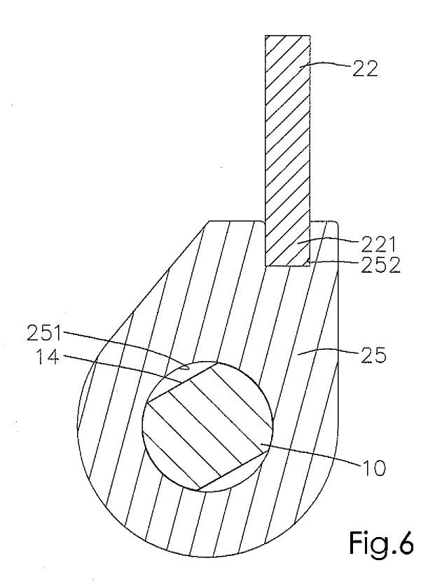

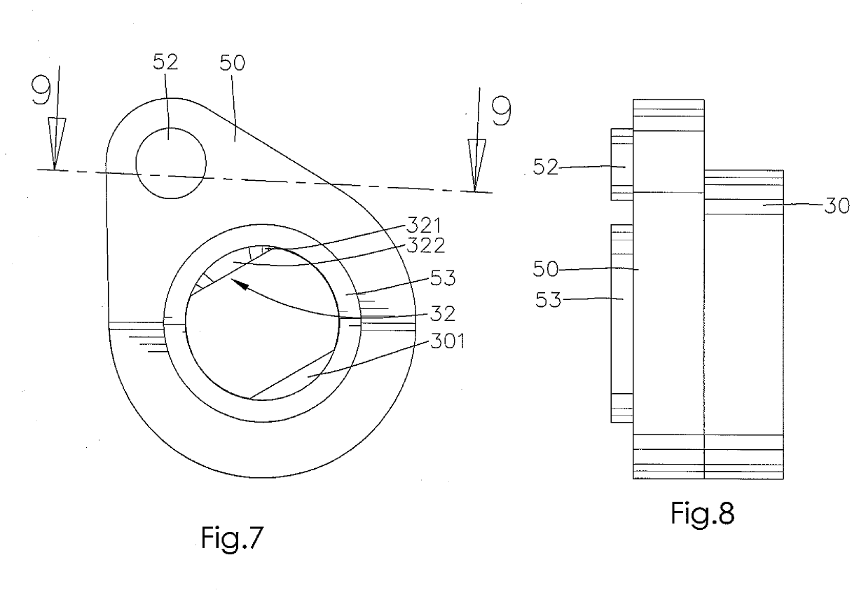

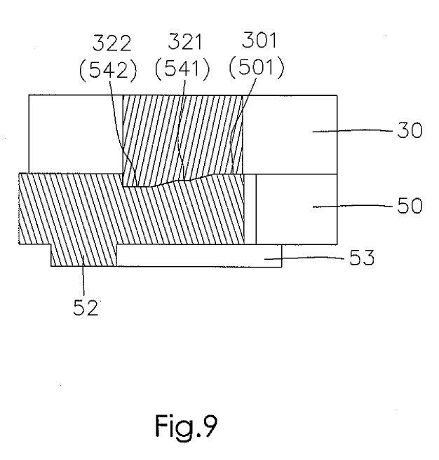

Referring to FIGS. 1 through 4, a multi-stage hinge assembly includes a first coupling member 10 having a neck 11 adapted to fix with a portable computer or the like. The neck 11 is formed at one distal end thereof and includes a shoulder 12 which extends therefrom. The shoulder 12 extends radially outwardly from the first coupling member 10 and is shaped in the form of a cylinder. The shoulder 12 further has a cutout 13 at its periphery. The coupling member 10 also has two first receiving surfaces 14, a second receiving surface 17 and an engaging portion 15 formed downstream with respect to the shoulder 12. In this preferred embodiment, the first receiving surface 14, the second receiving surface 17 and the engaging portion 15 are disposed at a different side of the shoulder 12 than the neck 11. Each first receiving surface 14 is substantially a flat surface formed along the outer periphery of second receiving surface 17 and extends along the length of the second receiving surface 17. However, each first receiving surface 14 does not extend entirely across the second receiving surface 17.

A second coupling member 20 is pivotally mounted on the first coupling member 10. The second coupling member 20 includes a first engaging portion 21 having an orifice 24 adapted to allow the insertion of the first coupling member 10, a second engagement portion 22 adapted to fix with the portable computer or the like and a slot 23. In this preferred embodiment, the second engagement portion 22 includes a tongue 221 formed thereon.

A plurality of support members 25 are pivotally mounted on the first coupling member 10 to allow a stable rotational movement of the second coupling member 20 with respect to the first coupling member 10. Each support member 25 includes a hole 251 adapted to allow the insertion of the first coupling member 10 and a recess 252 adapted to engage with the tongue 221 of the second engagement portion 22. Accordingly, when the second coupling member 20 is rotated with respect to the first coupling member 10, the plurality of support members 25 are jointly pivoted with respect to the first coupling member 10.

A first positioning member 30 is mounted on the first coupling member 10. The first positioning member 30 includes a bore 31 adapted to allow the insertion of the first coupling member 10. The bore 31 is shaped to have two perimeters matching the first receiving surfaces 14 and two perimeters matching the second receiving surface 17. In this case, the first positioning member 30 is restricted from rotating with respect to the first coupling member 10.

The first positioning member 30 also includes a first contacting surface 301 formed thereof. In this preferred embodiment, the first contacting surface 301 has three radially disposed gripping blocks 32 formed thereon. Each gripping block 32 is arcuate and has the same radius of curvature, but is distanced differently with respect to the bore 31. In addition, each gripping block 32 includes two second contacting surfaces 321 and a third contacting surface 322, with each second contacting surface 321 being equally spaced from and contiguously connected to the third contacting surface 322 by a sloped surface (not numbered). Each second contacting surface 321 also has another sloped surface (not numbered) contiguous connected thereto.

A plurality of resilient frictional devices 40 is also mounted on the first coupling member 10. Each resilient frictional device 40 is comprised of two spacers 41 and at least one resilient member 42 installed therebetween. Each spacer 41 has a bore 411 adapted to allow the insertion of the first coupling member 10 and a plurality of lubricant holes 412 for allowing lubricant to flow past the spacer 41. In this embodiment, each spacer 41 has three lubrication holes 412 formed thereon. The bore 411 is shaped to have two perimeters matching the first receiving surfaces 14 and two perimeters matching the second receiving surface 17. In this case, the first positioning member 30 is restricted from rotating with respect to the first coupling member 10. Each resilient member 42 has a hole 421 adapted to allow the insertion of the first coupling member 10 and a plurality of dents 422 formed in the perimeter wall thereof. In this preferred embodiment, the resilient member 42 has four dents 422 formed on the perimeter thereof.

A second position member 50 is pivotally mounted on the first coupling member 10. The second position member 50 includes a hole 51 adapted to allow the insertion of the first coupling member 10 and a protrusion 52 adapted to engage in the slot 23 of the second coupling member 20. Accordingly, when the second coupling member 20 is rotated with respect to the first coupling member 10, the second position member 50 is jointly pivoted with respect to the first coupling member 10. The second position member 50 also includes a ridge 53 adapted to be received in the orifice 24. Moreover, the second position member 50 includes a first contacting surface 501 formed thereof for interacting with the first contacting surface 301 of the first position member 30. In this preferred embodiment, the first contacting surface 501 has three positioning slots 54 corresponding to the gripping blocks 32 such that the gripping blocks 32 are moveable in and out of the respective positioning slots 54 when the second position member 50 is pivoted with respect to the first coupling member 10. Furthermore, each positioning slot 54 is arcuate and has the same radius of curvature, but is distanced differently with respect to the bore 31. Each positioning slot 54 includes two second contacting surface 541 and a third contacting surfaces 542, with each second contacting surface 541 being equally spaced from and contiguously connected to the third contacting surface 542 by a sloped surface (not numbered). Each second contacting surface 541 also has another sloped surface (not numbered) contiguous connected thereto.

A first position limiting member 60 is also mounted on the first coupling member 10. The first position limiting member 60 includes a hook 61 adapted to engage the cutout 13, a hole 64 adapted to allow the insertion of the first coupling member 10 and a plurality of V-shaped lubricant holes 62 for allowing lubricant to flow past the first position limiting member 60. The plurality of lubricant holes 62 are grouped in pairs, with each pair including two lubricant holes 62 having their open ends extending oppositely from each other and with each pair being disposed radially about the hole 64. The first position limiting member 60 also includes a position limiting area 63 along a portion of the perimeter thereof.

A second position limiting member 70 is pivotally mounted on the first coupling member 10. The second position limiting member 70 includes a hole 71 adapted to allow the insertion of the first coupling member 10 and a boss 72 adapted to engage in the slot 23 of the second coupling member 20. Accordingly, when the second coupling member 20 is rotated with respect to the first coupling member 10, the second position limiting member 70 is jointly pivoted with respect to the first coupling member 10. The second position limiting member 70 also includes a ridge 73 adapted to be received in the orifice 24. Moreover, the second position limiting member 70 includes a plurality of V-shaped lubricant holes 74 arranged radially about the hole 71. The plurality of lubricant holes 74 are also grouped in pairs, with each pair including two lubricant holes 74 having their open ends extending oppositely from each other. Furthermore, the second position limiting member 70 includes a projection 75 moveable within the position limiting area 63. The position limiting area 63 is adapted to limit pivoting movement of the second position limiting member 70.

As a first step in assembling the multi-hinge assembly, the first positioning limiting member 60 is moved into the first receiving surface 14 and the second receiving surface 17 until the hook 61 lockably engages the cutout 13, the second position limiting member 70 is then moved into the first receiving surface 14 and the second receiving surface 17 and pressed by the first positioning limiting member 60, the second coupling member is then moved into the first receiving surface 14 and the second receiving surface 17 and pressed against the second position limiting member 70, the second positioning member is then moved into the first receiving surface 14 and the second receiving surface 17 until the ridge 53 engages in the orifice 24, the first positioning member 30 is then moved into the first receiving surface 14 and the second receiving surface 17 until the gripping blocks 32 complemently fits into the corresponding positioning slots 54, one of the plurality of resilient frictional devices 40 is then moved into the first receiving surface 14 and the second receiving surface 17 and pressed against the first positioning member 30, and one of the plurality of support members 25 is then moved into the first receiving surface 14 and the second receiving surface 17 and pressed against the aforementioned resilient frictional device 40. The plurality of resilient frictional devices 40 and the plurality of support members 25 are arranged in this way to provide a biasing force acting upon the first positioning member 30. A retainer 16 is then used to engage the engaging portion 15.

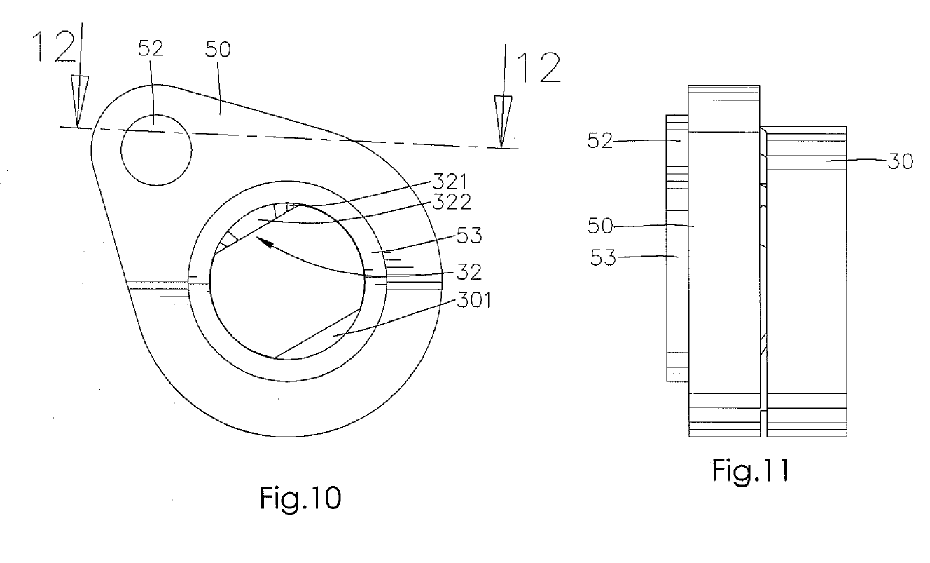

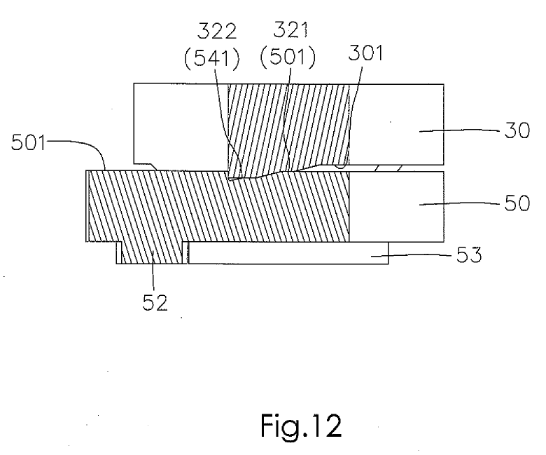

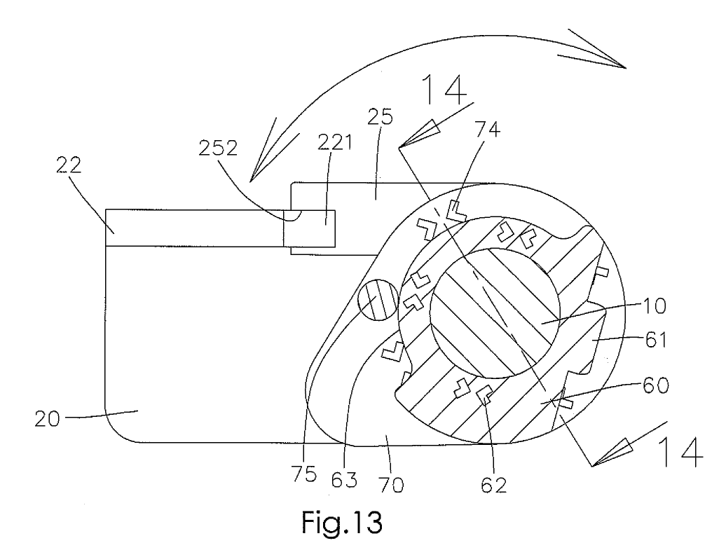

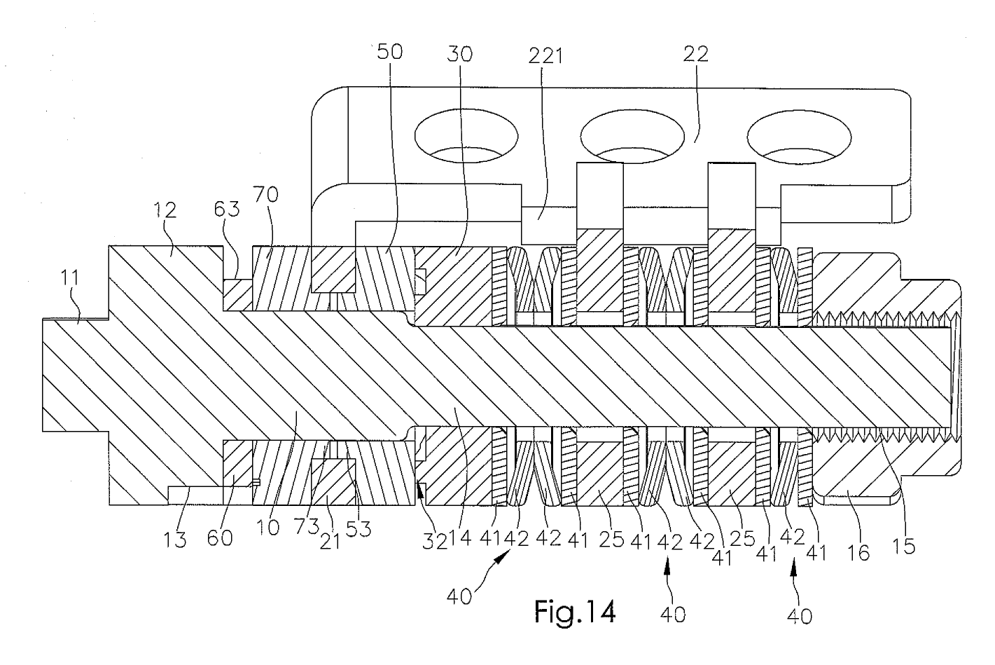

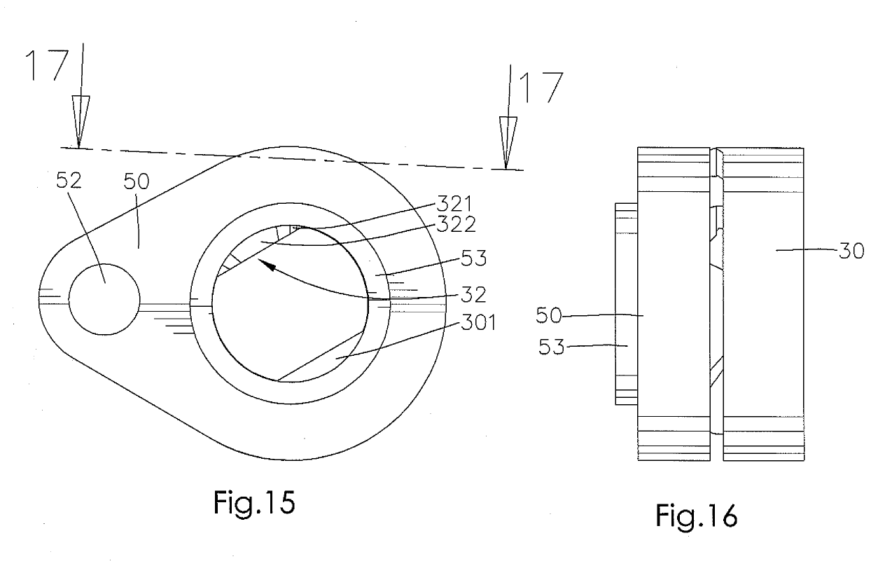

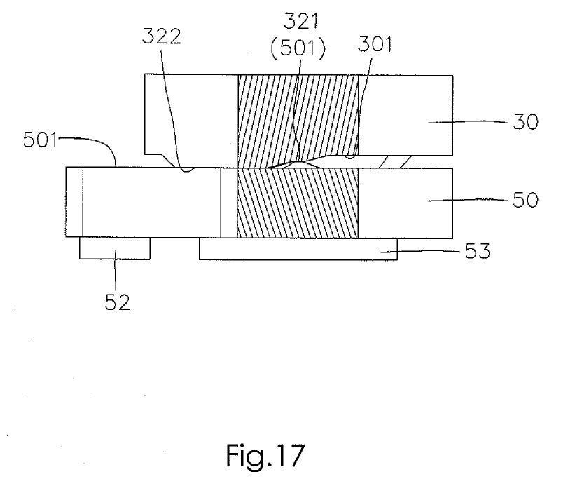

Referring to FIGS. 10 through 17, the gripping blocks 32 are adapted to move in the corresponding positioning slots 54 or on the first contacting surface 501 of the second positioning member 50 to thereby providing differential frictional forces.

In view of forgoing, it is an advantage of the present invention that the first positioning member 30 and the second positioning member 50 are adapted to provide differential frictional forces.

Another advantage of the present invention is that the plurality of the V-shaped lubricant holes 62, 74 are adapted to maintain lubricant between the first positioning limiting member 60 and the second positioning limiting member 70 regardless the second coupling member 20 is rotated clockwise/anticlockwise with the first coupling member 10.

Yet another advantage of the present invention is to provide the plurality of resilient frictional devices 40 and support members 25 for allowing the portable computer or the like to open/close with greater steadiness and to be firmly remained in a static position.

While the specific embodiments have been illustrated and described, numerous modifications come to mind without significantly departing from the spirit of invention and the scope of invention is only limited by the scope of accompanying claims.

What is claimed is:

1. A multi-stage hinge assembly comprising:
a first coupling member adapted to fix with a portable computer and receivable with a second coupling member, a first positioning member, a plurality of resilient frictional devices, a second positioning member and a retainer, with the retainer being adapted to prevent the second coupling member, the first positioning member, the plurality of resilient frictional devices, and the second positioning member from disengaging with the first coupling member; and
wherein the second coupling member includes a first engagement portion pivotally mounted on the first coupling member and a second engagement portion adapted to fix with a portable computer;
wherein the first positioning member defines a first contacting surface with a plurality of radially disposed gripping blocks formed thereon, with each gripping block being arcuate and having the same radius of curvature, and with each gripping block disposed at different distances with respect to the first coupling member;
wherein the plurality of resilient frictional devices are installed between the first positioning member and the retainer; and
wherein the second positioning member defines a first contacting surface, with a plurality of positioning slots corresponding with the plurality of gripping blocks, and with each gripping block being adapted to complemently fit into the corresponding position slot and move in the positioning slot and on the first contacting surface of the second positioning member.

2. A multi-stage hinge assembly as claimed in claim 1 further includes a first positioning limiting member and a second positioning limiting member both pivotally mounted on the first coupling member, with the first positioning limiting member being adapted to limit pivoting movement of the second positioning limiting member, with the second positioning limiting member engaging with the first engagement portion of the second coupling member, with the second positioning limiting member having a plurality of V-shaped lubricant holes, with the plurality of V-shaped lubricant holes being grouped in pairs, and with each pair including two lubricant holes having their open end extending oppositely from each other.

3. A multi-stage hinge assembly as claimed in claim 1 wherein each gripping block includes two second contacting surfaces and a third contacting surface, with each second contacting surface being equally spaced from and contiguously connected to the third contacting surface by a sloped surface.

4. A multi-stage hinge assembly as claimed in claim 1 wherein each of the plurality of resilient frictional devices includes two spacers and at least one resilient member installed therebetween.

5. A multi-stage hinge assembly as claimed in claim 4 wherein each spacer has a bore adapted to allow insertion of the first coupling member, with the bore being non-circular, and the resilient member has a hole adapted to allow insertion of the first coupling member, with the hole being circular.

6. A multi-stage hinge assembly as claimed in claim 1 wherein the second coupling member includes a slot defined thereon, and the second positioning member includes a protrusion engaging in the slot such that the second coupling member and the second positioning member pivot together with respect to the first coupling member.

7. A multi-stage hinge assembly as claimed in claim 2 wherein the first positioning limiting member includes a plurality of V-shaped lubricant holes, with the plurality of V-shaped lubricant holes being grouped in pairs, and with each pair including two lubricant holes having their open end extending oppositely from each other.

8. A multi-stage hinge assembly as claimed in claim 2 wherein the first positioning limiting member includes a positioning limiting area along a portion of the perimeter thereof, and the second positioning member includes a projection moveable within the positioning limiting area, and with the positioning limiting area being adapted to limit pivoting movement of the second positioning limiting member.

9. A multi-stage hinge assembly as claimed in claim 2 wherein the second positioning member includes a boss engaging in the slot such that the second coupling member and the second positioning limiting member pivot together with respect to the first coupling member.

10. A multi-stage hinge assembly as claimed in claim 1 further includes a plurality of support members pivotally mounted on the first coupling member, and the second engagement portion of the second coupling member includes a tongue formed thereof for receiving the plurality of support members such that the second coupling member and the plurality of support members pivot together with respect to the first coupling member.
